(19) United States
(12) Patent Application Publication
(10) Pub. No.: US 2024/0393228 A1
(43) Pub. Date: Nov. 28, 2024

(54) Methods And Systems For Detecting A Sample Via Optical Pathways

(71) Applicants: Thermo Electron Scientific Instruments LLC, Madison, WI (US); Life Technologies Corporation, Carlsbad, CA (US)

(72) Inventors: Julian James Irwin, Madison, WI (US); Wesley Glen Smith, Eugene, OR (US)

(21) Appl. No.: 18/673,469

(22) Filed: May 24, 2024

Related U.S. Application Data
(60) Provisional application No. 63/504,453, filed on May 26, 2023.

(51) Int. Cl. G01N 15/1434; G01N 15/10

(52) U.S. Cl. CPC G01N 15/1434; G01N 2015/1006

(57) ABSTRACT

Methods and systems for detecting a sample via optical pathways are described herein. In one aspect, a light detection system can include: a first optical pathway configured to direct emissions from an interrogation site to a first detector; a second optical pathway configured to direct emissions from the interrogation site to a second detector; and an automated switching module configured to receive a signal that induces the automated switching module to switch between (i) a first state that directs emissions from the interrogation site to the first optical pathway or a second state that directs emissions from the interrogation site to the second optical pathway and (ii) the other of the first state and the second state.

### CROSS-REFERENCE TO RELATED APPLICATIONS

This application claims priority to and the benefit of U.S. Provisional Application No. 63/504,453, “Methods and Systems for Detecting a Sample via Optical Pathways” (filed May 26, 2024), the entirety of which application is incorporated herein by reference for any and all purposes.

### TECHNICAL FIELD

The present invention relates generally to detection of samples in systems relying on optical pathways.

### BACKGROUND

Full spectrum flow cytometry typically can include a large numbers of lasers, photomultiplier tubes (PMTs), dichroic mirrors and bandpass filters, which arrangements can be complex and costly. A less complex and more cost-effective solution can be a dispersive spectrograph and a line sensor with hundreds or thousands of pixels. One challenge associated with an order of magnitude increase in the number of spectral channels is timely data processing and throughput. Faster sample event rates increase sample throughput and save time, so average sample event rates in cytometers are routinely in the tens of kilohertz. The actual sample arrival times can be random and follow Poisson statistics, so samples can regularly arrive at intervals well below the average rate, even arriving back-to-back or simultaneously. The twin factors of increased spectral channels and microsecond sample separations place stringent requirements on readout if no samples are to be missed. Line sensors based on typical charge coupled device (CCD) and scientific complementary metal oxide semiconductors (sCMOS) cannot meet these readout speed requirements, as these sensors typically require read amplifiers that fundamentally increase noise as they increase speed.

Another option for a spectrograph sensor is a single photon avalanche detector (SPAD) array line sensor that can count photons as digital bits. The digital information can be clocked out very quickly without any increase in noise. SPAD arrays, however, can require 10 μs or longer to read out data. Read times of this length can result in the loss of some back-to-back sample events.

Thus, sample interrogation systems, such as flow cytometry systems, can benefit from full spectrum data, but detectors such as CCD and sCMOS line sensors are too slow. Photon counting detectors like SPAD arrays can record photons as digital bits, and may not experience the tradeoff between read amplifier noise and speed. There are, however, still challenges associated with retrieving digital data off SPAD array chips fast enough, in part because the existing generation of chips are general purpose and not instrument-specific. Accordingly, there is a need in the art for sample interrogation systems capable of detecting sample emissions having quick sample event rates.

### SUMMARY

Methods and systems for detecting a sample via optical pathways are described herein. In one aspect, a light detection system can include: a first optical pathway configured to direct emissions from an interrogation site to a first detector; a second optical pathway configured to direct emissions from the interrogation site to a second detector; and an automated switching module configured to receive a signal that induces the automated switching module to switch between (i) a first state that directs emissions from the interrogation site to the first optical pathway or a second state that directs emissions from the interrogation site to the second optical pathway and (ii) the other of the first state and the second state.

### BRIEF DESCRIPTION OF THE DRAWINGS

For the purpose of illustrating the invention, there is shown in the drawings a form that is presently preferred; it being understood, however, that this invention is not limited to the precise arrangements and instrumentalities shown.

FIG. 1 depicts a flow cytometry system according to the present disclosure.

FIGS. 2-6 depict example systems according to the present disclosure.

FIG. 7 depicts a process flow for interrogating samples according to the present disclosure.

FIG. 8 depicts a controller for sample interrogation systems according to the present disclosure.

FIG. 9 depicts an example, non-limiting timeline of modes for a detector configured to be implemented according to the present disclosure.

FIG. 10 depicts an example, non-limiting state diagram for switching modes of a detector configured to be implemented according to the present disclosure.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order. Any documents cited herein are incorporated by reference in their entireties for any and all purposes.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

Methods and systems for detecting sample emissions via optical pathways are described herein. In some examples, the disclosure discusses a dual sensor spectrograph for full spectrum flow cytometry. The effective dead time of the spectrograph can be reduced by activating the second sensor when the first sensor is busy reading out data. This will reduce the number of missed sample events. The methods described herein can thus facilitate full spectrum emission capturing and reading for systems having quick sample event rates, such as those experienced in flow cytometry.

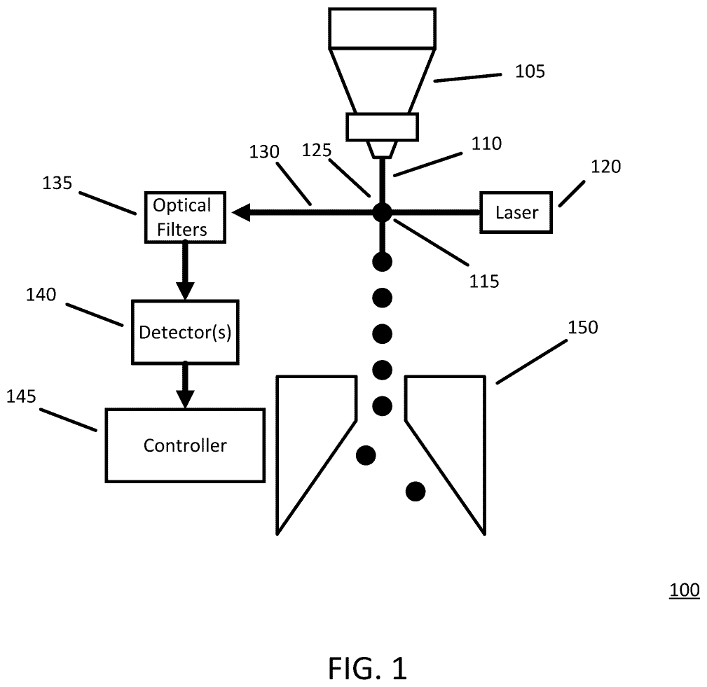

FIG. 1 depicts a flow cytometry system 100 according to the present disclosure. A sample can be sent through a nozzle 105 under pressurized conditions and can create a stream 110 at the output of the nozzle 105. The stream 110 breaks off into a series of droplets 115. Laser 120 can irradiate samples that may contain, for example, cells at interrogation site 115. Depending upon the type of sample that is irradiated by the laser 120, the sample can generate an optical response. The optical response may include forward scattered light or forward fluorescent emissions 130. Alternatively, or in addition, the response of the sample to the irradiation by laser 120 may include side-scattered light, or side fluorescent emissions. These responses are transmitted through spectral separation optics 135—which can be, for example, optical filters, dispersion components, and the like—to detector 140.

The detector 140 can generate output signals that have a magnitude that is indicative of the intensity of the light collected from the cell, at the specific frequencies of the spectral separation optics 135. In some cases, the controller 145 can generate an event data signal based on the output signals received from the detector 140. For example, the event data signal can include a time stamp to identify the data with a particular cell. In some cases, the event data signal can include sorting information. For example, the controller 145 can implement sorting logic to perform sort decisions that are based upon the biological response of the particular types of cells that are being sorted. Statistical calculations of the likelihood of an event belonging to a certain population can be used for making the sort decision. The event data signal can be used to control deflector plates 150 to charge a droplet prior to breaking off from the stream 110, for example, for sorting purposes. In some cases, the output signals from the detector 140 can include a photocount value.

The disclosure provided herein is not limited to the particular flow cytometry system 100 depicted in FIG. 1, and is used for illustrative purposes. For example, the methods described herein can be implemented by a flow cytometry system having various lasers of different wavelengths, various spectral separation optics for filtering or directing emissions, various deflector plates or mechanisms for sorting samples, and the like. Other systems that rely on optical pathways for sample interrogation can also implement the processes described herein, such as confocal laser scanning microscopes, and the like.

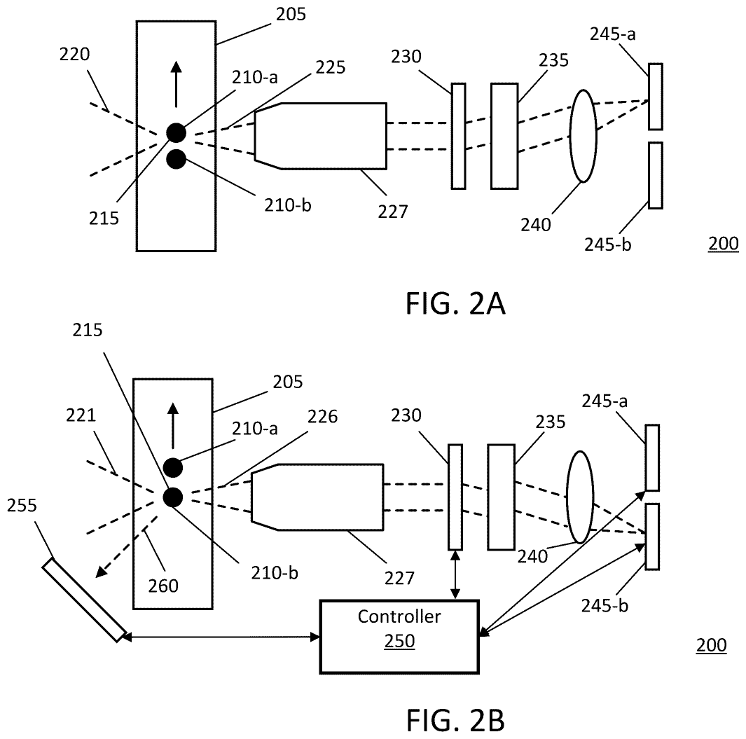

FIGS. 2A and 2B depict a system for sample interrogation according to the present disclosure. In some cases the system 200 can be a part of a flow cytometry system, such as system 100 described with reference to FIG. 1. In some cases, the system 200 can be implemented in other sample interrogation system.

The system 200 can include a sample collection 205, which can position samples, or facilitate positioning of the samples, for interrogation by the system 200. In the case of a flow cytometer, the sample collection 205 can be a stream of samples, such as stream 110 of FIG. 1. In the case of a laser scanning microscope, the sample collection 205 can be a sample slide or other mount.

One or more samples can be positioned at an interrogation site of the system 200. For example, in FIG. 2A, a first sample 210-a can be positioned at the interrogation site 215. An optical signal 220 can be configured to interact with a sample while the sample is at the interrogation site 215. For example, the optical signal 220 can be a laser beam or a laser pulse of a particular wavelength or mixture of wavelengths.

Emissions 225 can result in the interaction between the first sample 210-a and the optical signal 220. In some cases, the emissions 225 can be fluorescence or a particular wavelength or wavelengths that are dependent on the optical signal wavelength and the composition of the first sample. The emissions 225 travel from the first sample 210-a via an optical pathway. The optical pathway can include a variety of optical components. In some cases, the optical pathway can include a lens system 227, which can collect fluorescence of the sample and direct the emissions further along the optical pathway. The optical pathway can also include a switching element 230. The switching element 230 can be configured to direct the emissions 225 towards a first detector 245-a. For example, the switching element 230 can include a mechanical actuator that can reposition the switching element 230 to direct the emissions 225 towards a desired target. In some cases, the switching element 230 can be an active mechanical switching element, which can be, for example, a galvo mirror; an active electrical switching element, which can be, for example, a Pockels cell crystal or other electro-optic material; a passive switching element, which can be, for example, a beam splitter; and the like.

The emissions 225 can travel from the switching element 230 to other components of the optical pathway. For example, the emissions 225 can travel from the switching element 230 to a grating 235, and to a lens 240, which can then direct the emissions 225 to the first detector 245-a. However, one skilled in the art will understand that other optical components along the optical pathway can be added, replaced, or removed, either prior to the splitting mechanism 230, or after the splitting mechanism 230.

Detectors 245-a and 245-b may include, for instance, SPAD detectors. In some cases, detectors 245-a and 245-b can be components in a detector array. In some cases, detectors 245-a and 245-b can be separate, designated pixel groups of a SPAD detector.

In FIG. 2B, the first sample 210-a can pass from the interrogation site 215, and the second sample 210-b can enter the interrogation site 215, for example via a fluid flow through the sample collection 205. The second sample 210-b can interact with an optical signal 221, which can be—but does not need to be—the optical signal 210 of FIG. 2A. In some cases, the optical signal 211 can be another laser pulse. Emissions 226 can result from the interaction between the second sample 210-b and the optical signal.

The emissions 226 can travel via the optical pathway to the switching element 230. In some cases, the switching element 230 can include an actuator mechanism, and can be reoriented in anticipation of or even on receipt of emissions 226 from second sample 210-b. For example, the switching element 230 can be actuated to redirect the emissions 226 to the second detector 245-b, for example, through the other optical components of the optical pathway, such as grating 235 and lens 240. In some cases, the switching element 230 can be a beam splitter, and can redirect the emissions in different directions based on characteristics of the emissions, based on a voltage applied across the switching element 230, and the like. Without being bound to any particular theory or embodiment, the switching element 230 can operate so as to direct emissions to second detector 245-b when first detector 245-a is in readout mode, or vice versa.

Thus, emissions can travel to different detectors based on the orientation, positioning, or applied voltage of the switching element. In some cases, the emissions can travel a shared portion of an optical pathway, and then deviate towards different detectors based on the switching element 230. For example, in FIG. 2A, the emissions 225 can be considered to deviate from a shared optical pathway at switching element 230. Likewise in FIG. 2B, the emissions 226 can be considered to deviate from a shared optical pathway at the switching element 230.

In some cases, the switching element 230 can be configured or instructed to direct the emissions towards a particular detector based on which sample is being interrogated, for example at the interrogation site. For example, a controller 250 can be configured to instruct the switching element 230 to direct the emissions from the first sample towards the first detector, and the controller 250 can be configured to instruct the switching element 230 to direct the emissions form the second sample to the second detector. In some cases, the controller 250 can monitor the time the switching element 230 is positioned or oriented for a predefined period time, which can correspond to a sample being positioned at the interrogation site. Once the period of time lapses, the controller 250 can reset the time period and instruct the switching element 230 to reorient or reposition to direct emissions from another sample to another detector. In some cases, the controller 250 can monitor the emissions received by a detector or detectors and, based on a reception time for emissions, can begin a countdown, such as a predefined time period. Once the countdown lapses, the controller 250 can instruct the switching element 230 to reposition or reorient. In some cases, the controller 250 can monitor backscattering and/or side scattering received from the interrogation site. For example, the controller can be in communication with a backscattering detector 255. The controller 250 can determine a first sample is at the interrogation site based on the backscattering received from emissions 260 of the sample. This can indicate that the first sample is at the interrogation site. The controller 250 can determine an initiation of a time period for the switching element 230 to be positioned or oriented towards a particular detector based on the backscattering. In some cases, the controller 250 can instruct the switching element 230 to reposition or reorient towards another detector based on a change in the backscattering received, which can indicate that the sample has left the interrogation site, or that another sample is entering the interrogation site.

In some cases, such as those cases in which passive switching elements are involved, the detectors can be instructed—for example, via the controller 250—to be activated to measure, or to measure the emissions. For example, a detector can be active for a predefined time period, which can coincide with a sample being positioned at the interrogation site. In some cases, the predefined time period can also include an additional offset time, which can account for any delay in detecting the sample has entered or exited the interrogation site and a detector entering into an activated/measurement state.

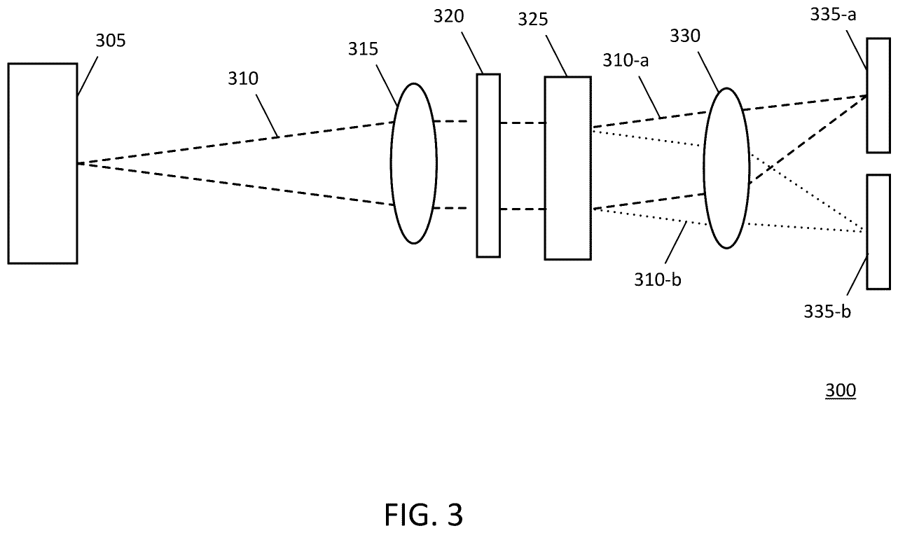

FIG. 3 depicts a system 300 for sample interrogation according to the present disclosure. The system 300 can include an optical slit 305, which can receive and transmit emissions 310 resulting from an interrogation of a sample, for example sample 210-a or 210-b as depicted in FIGS. 2A and 2B. The emissions 310 can travel an optical pathway that includes a number of optical components. For example, the optical pathway can include a lens 315, a beam splitter 320, a grating 325, and a lens 330. In some cases, the optical pathway can also include the slit 305. One skilled in the art will understand that the components of the optical pathway can be added to, subtracted from, or replaced, and that the positioning of the optical components can be altered. Also, while not shown, a controller, such as controller 250 of FIG. 2, can be implemented in the system 300 to control detector activation.

The lens 315 can receive and transmit the emissions 310 to the beam splitter 320. The beam splitter can be configured to split the emissions 310 into a number of divergent emissions. For example, the beam splitter 320 can be configured to split the emissions 310 into first emissions 310-a and second emissions 310-b. In some cases, the first emissions 310-a and the second emissions 310-b can be divergent based on wavelengths, such that the first emissions 310-a and the second emissions 310-b carry different emission wavelengths. In some cases, the first emissions 310-a and the second emissions 310-b can be divergent based on spacing or polarization, such that the first emissions 310-a and the second emissions 310-b contain the same or shared wavelengths. In some cases, the beam splitter 320 can be a passive beam splitter, where the beam splitter 320 is statically positioned during the sample interrogation process, for example, across different samples. In some cases, the beam splitter can be a diffractive optical element, such as a dual focus diffractive optical element.

The grating 325 can further spatially separate the first emissions 310-a and the second emissions 310-b from one another. The separation characteristics of the grating 325 can be based on wavelength properties, spatial properties, phase properties, and the like. The lens 330 can direct each of the first emissions 310-a and the second emissions 310-b to the detectors 335-a and 335-b. Thus, in the scenario of FIG. 3, each detector 335-a, 335-b can receive the first emissions 310-a and the second emissions 310-b.

Detectors 335-a, 335-b can be SPAD detectors. In some cases, detectors 335-a, 335-b can be components of a detector array. In some cases, detectors 335-a, 335-b can be separate, designated pixel groups of a SPAD detector.

The detectors 335-a, 335-b can be configured to activate to measure, or measure the first emissions 310-a and the second emissions 310-b based on which sample is being interrogated. For example, the detector 3350a can be configured to activate to measure, or measure, the first emissions 310-a and the second emissions 310-b resulting from a first sample being interrogated. Thus, the detector 335-b can be inactive, or ignore, the first emissions 310-a and the second emissions 310-b for the first sample. The detector 335-b can then be activated to measure, or measure the first emissions 310-a and the second emissions 310-b resulting from a second sample being interrogated, for example after the first sample has exited the interrogation site. In some cases, the detectors 335-a, 335-b can be instructed—for example, via a controller—to be activated to measure, or measure the first emissions 310-a and the second emissions 310-b. For example, a detector can be active for a predefined time period, which can coincide with a sample being positioned at the interrogation site. In some cases, the predefined time period can also include an additional offset time, which can account for any delay in detecting the sample has entered or exited the interrogation site and a detector entering into an activated/measurement state.

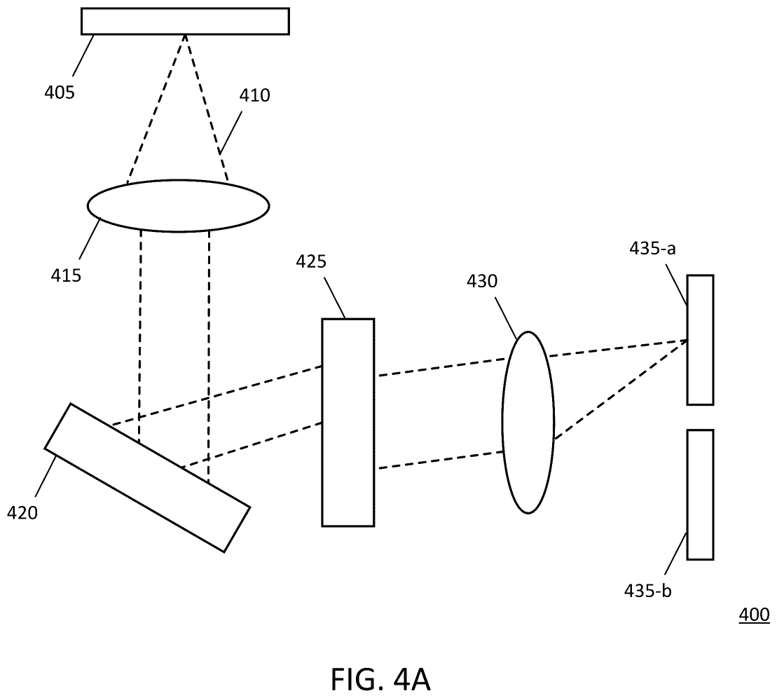

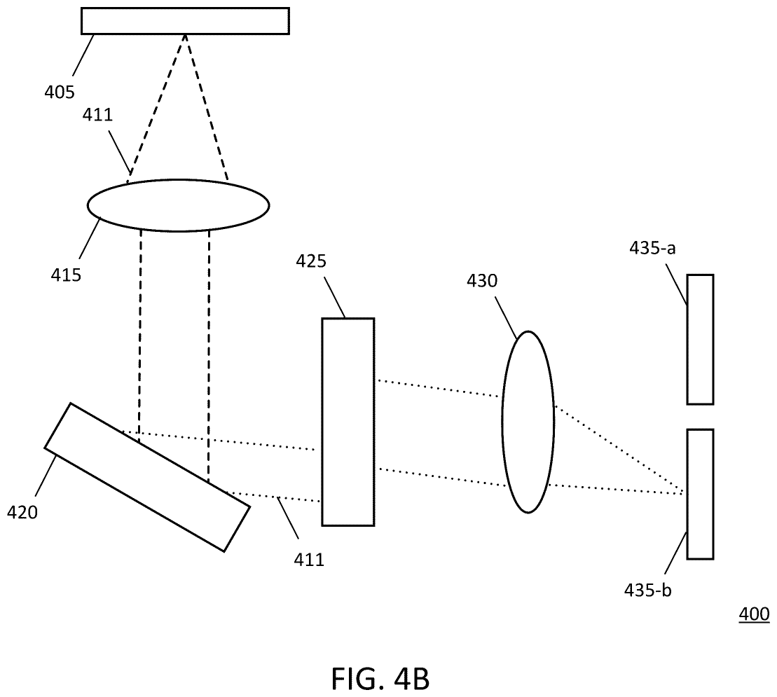

FIGS. 4A and 4B depict a system for sample interrogation according to the present disclosure. The system 400 can include an optical slit 405, which can receive and transmit emissions 410 and 411 resulting from interrogation of samples, for example, sample 210-a and 210-b as depicted in FIGS. 2A and 2B. The emissions 410—which can be from a first sample—can travel an optical pathway that includes a number of optical components. For example, the optical pathway can include a lens 415, a mechanical actuator 420, a grating 425, and a lens 430. In some cases, the optical can also include the slit 405. One skilled in the art will understand that the components of the optical pathway can be added to, subtracted from, or replaced, and that the positioning of the optical components can be altered. Also, while not shown, a controller, such as controller 250 of FIG. 2, can be implemented in the system 400 to control detector activation.

The lens 415 can receive and transmit the emissions 410 to the mechanical actuator 420. The mechanical actuator 420 can be positioned or oriented to direct the emissions 410 through the optical pathway such that the emissions 410 are received by the first detector 435-a. The grating 425 can diffract the emissions 410. The separation characteristics of the grating 425 can be based on wavelength properties, spatial properties, phase properties, and the like. The lens 430 can direct the emissions 410 towards the first detector 435-a.

In FIG. 4B, the system 400 can receive emissions 411 from another sample. For example, the other sample can be a sample immediately preceding the sample interrogated in FIG. 4A. The optical slit 405 can receive and transmit emissions 411 from the other sample. The emissions 411 can travel the optical pathway, and can be redirected by the mechanical actuator 420. The mechanical actuator 420 can be reoriented or repositioned to direct the emissions 411 to the second detector 435-b. For example, the mechanical actuator 420 can receive a communication—for example, from a controller—instructing the mechanical actuator to reposition or reorient. The grating 425 can diffract the emissions 411, and the lens 430 can direct the emissions toward the second detector 435-b.

Detectors 435-a, 435-b can be SPAD detectors. In some cases, detectors 435-a, 435-b can be components of a detector array. In some cases, detectors 435-a, 435-b can be separate, designated pixel groups of a SPAD detector.

In some cases, the detectors 435-a, 435-b can be configured to activate to measure, or measure the emissions 410 and the emissions 411 based on which sample is being interrogated. For example, the detector 435-a can be configured to activate to measure, or measure, the emissions 410 resulting from a first sample being interrogated. Thus, the detector 435-b can be inactive, or ignore, the emissions 410 for the first sample. The detector 435-b can then be activated to measure, or measure the emissions 411 resulting from a second sample being interrogated, for example after the first sample has exited the interrogation site. A detector can be active for a time period, which can coincide with a sample being positioned at the interrogation site. In some cases, the predefined time period can also include an additional offset time, which can account for any delay in detecting the sample has entered or exited the interrogation site and a detector entering into an activated/measurement state. Likewise, the mechanical actuator 420 in some cases can be in a particular position for the predefined time period. After expiration of the time period, the mechanical actuator 420 can reposition or reorient for emissions of a subsequent sample being interrogated.

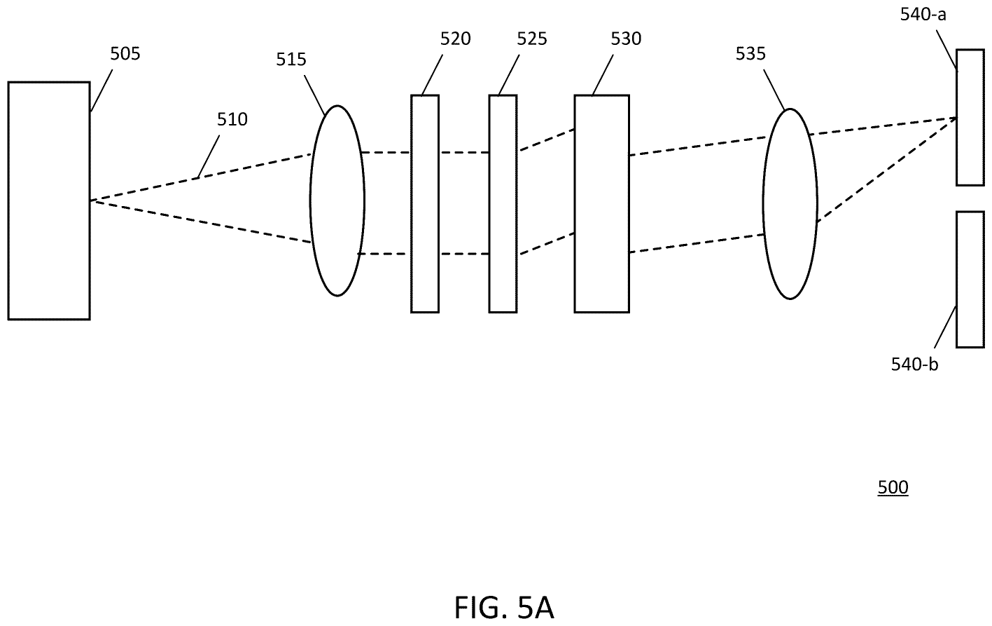

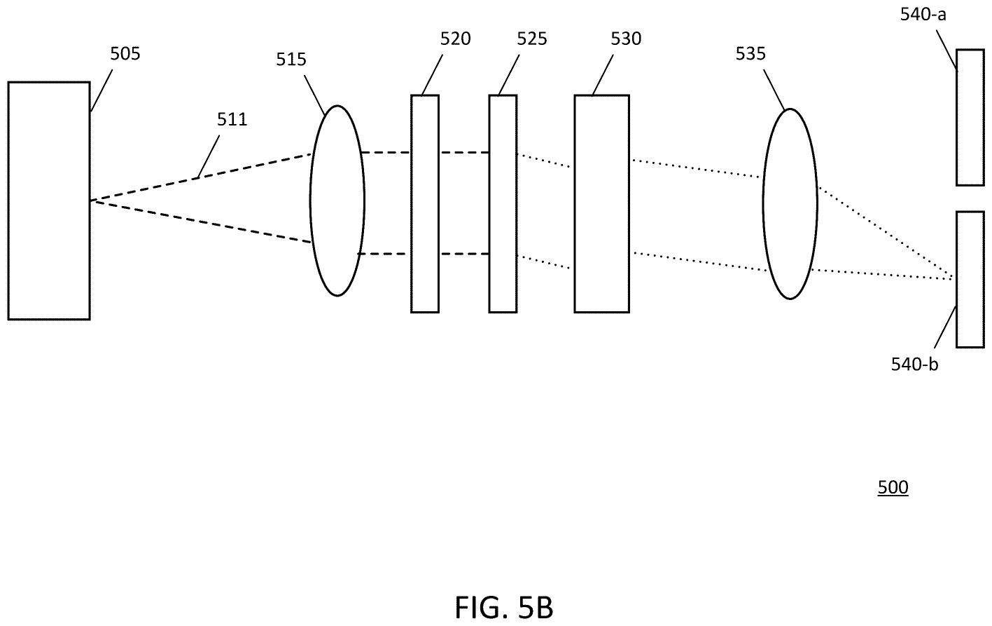

FIGS. 5A and 5B depict a system 500 for sample interrogation according to the present disclosure. The system 500 can include an optical slit 505, which can receive and transmit emissions 510 and 511 resulting from an interrogation of a sample, for example, sample 210-a or 210-b as depicted in FIGS. 2A and 2B. The emissions 510—from a first sample—can travel an optical pathway that includes a number of optical components. For example, the optical pathway can include a lens 515, an Electro-optic modulator (EOM) 520, a polarization separation optic 525, a grating 530, and a lens 535. In some cases, the optical can also include the slit 505. One skilled in the art will understand that the components of the optical pathway can be added to, subtracted from, or replaced, and that the positioning of the optical components can be altered. Also, while not shown, a controller, such as controller 250 of FIG. 2, can be implemented in the system 500 to control detector activation.

The lens 515 can receive and transmit the emissions 510 to the EOM 520. In some cases, the EOM 520 can be a voltage-controlled wave plate that can be configured to direct the emissions 510 through the optical pathway and towards the first detector 540-a. In some cases, the EOM 530 can include a Pockels cell. The EOM 520 can modify the polarization of the emissions 410 based on the voltage applied to the EOM 520. The polarization separation optic 525 can direct the emissions 510 through the optical pathway and towards the first detector 540-a based on the polarization of the emissions 510. In some cases, the polarization separation optic 525 can include a Wollaston prism or other polarizing crystal, polarizing beam splitters, Brewster windows, and the like. The grating 530 can diffract the emissions 510. The separation characteristics of the grating 530 can be based on wavelength properties, spatial properties, phase properties, and the like. The lens 535 can direct the emissions 510 towards the first detector 540-a.

In FIG. 5B, the system 500 can receive emissions 511 from another sample. For example, the other sample can be a sample immediately preceding the sample interrogated in FIG. 5A. The optical slit 505 can receive and transmit emissions 511 from the other sample. The emissions 511 can travel the optical pathway, through the lens 515, and can be polarized by the EOM 520. The polarization can be different than the emissions 510 of FIG. 5A, and can be configured to direct the emissions 511 to the second detector 540-b. For example, a different voltage can be applied to the EOM 520, which can cause a different polarization to the emissions 511 compared to the emissions 510. The polarization separation optic 525 can direct the emissions 511 through the optical pathway and towards the second detector 540-b based on the polarization of the emissions 511. The grating 530 can diffract the emissions 511, and the lens 535 can direct the emissions 510 towards the second detector 540-b.

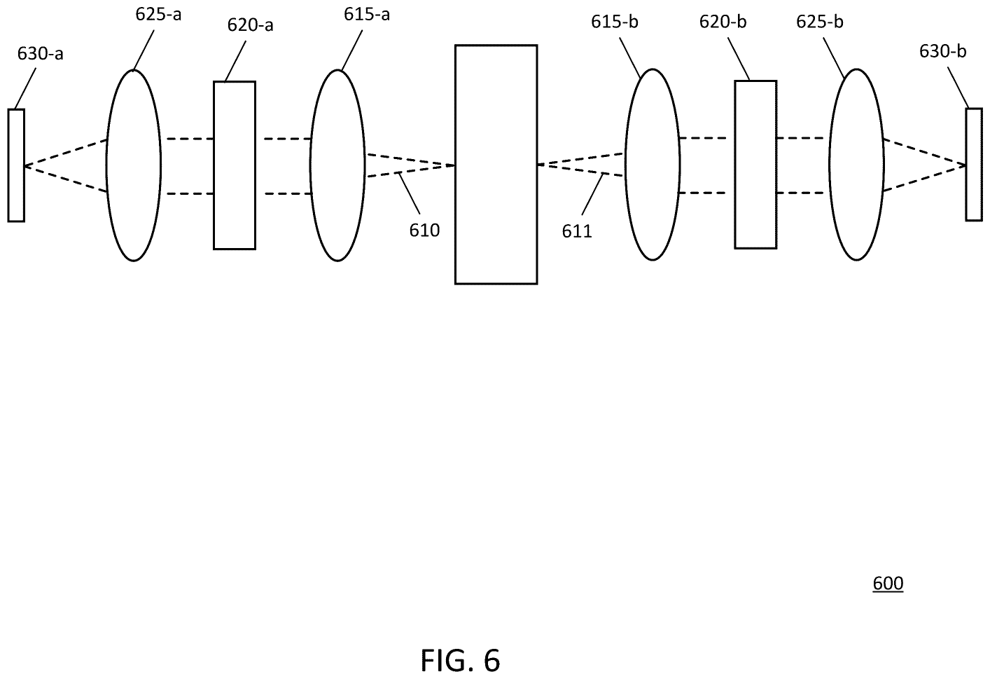

FIG. 6 depicts a system 600 for sample interrogation according to the present disclosure. The system 600 can include multiple optical pathways. Each optical pathway can originate at the sample being interrogated. For example, in a flow cytometry application, the optical pathways can originate at the interrogation site of the sample stream. The sample can interact with the sample, and emissions can be emitted in different directions from the interrogated sample. The optical pathways can be positioned or configured to receive a portions of these emissions. For example, a first optical pathway can be positioned to receive a first portion of emissions that are emitted in a particular direction, and a second optical pathway can be configured to receive a second portion of emissions that are emitted in a direction different from the first portion.

Each optical pathway can include a number of optical components. For example, the one optical pathway can include a lens 615-a, a grating 620-a, and a lens 625-a. Another optical pathway can include a lens 615-b, a grating 620-b, and a lens 625-b. One skilled in the art will understand that the components of the optical pathways can be added to, subtracted from, or replaced, and that the positioning of the optical components can be altered. Further, one skilled in the art will understand that the optical components of the optical pathways can be different from one another. Also, while not shown, a controller, such as controller 250 of FIG. 2, can be implemented in the system 600 to control detector activation.

The lens 615-a, 615-b can receive and transmit the emissions 610, 611 and transmit to the grating 620-a, 620-b, respectively. The grating 620-a, 620-b can diffract the emissions 610, 611 respectively. The separation characteristics of the grating 620-a, 620-b can be based on wavelength properties, spatial properties, phase properties, and the like. The lens 625-a, 625-b can direct the emissions 610, 611 towards the first detector 630-a and the second detector 630-b, respectively.

Detectors 630-a, 630-b can be SPAD detectors. In some cases, detectors 630-a, 630-b can be components of a detector array. In some cases, detectors 630-a, 630-b can be separate, designated pixel groups of a SPAD detector.

In some cases, the detectors 630-a, 630-b can be configured to activate to measure, or measure the emissions 610 and the emissions 611 based on which sample is being interrogated. For example, the detectors 630-a and 630-b can be configured to receive the emissions 610 and 610, respectively, for each sample interrogated. However, the detector 630-a can be configured to activate to measure, or measure, the emissions 610 resulting from a first sample being interrogated. Thus, the detector 630-b can be inactive, or ignore, the emissions 611 for the first sample. The detector 630-b can then be activated to measure, or measure the emissions 611 resulting from a second sample being interrogated (e.g., after the first sample has exited the interrogation site), where the detector 630-a can be instructed to be inactive or ignore the emissions 610 of the second sample.

A detector can be active for a time period, which can coincide with a sample being positioned at the interrogation site. In some cases, the predefined time period can also include an additional offset time, which can account for any delay in detecting the sample has entered or exited the interrogation site and a detector entering into an activated/measurement state.

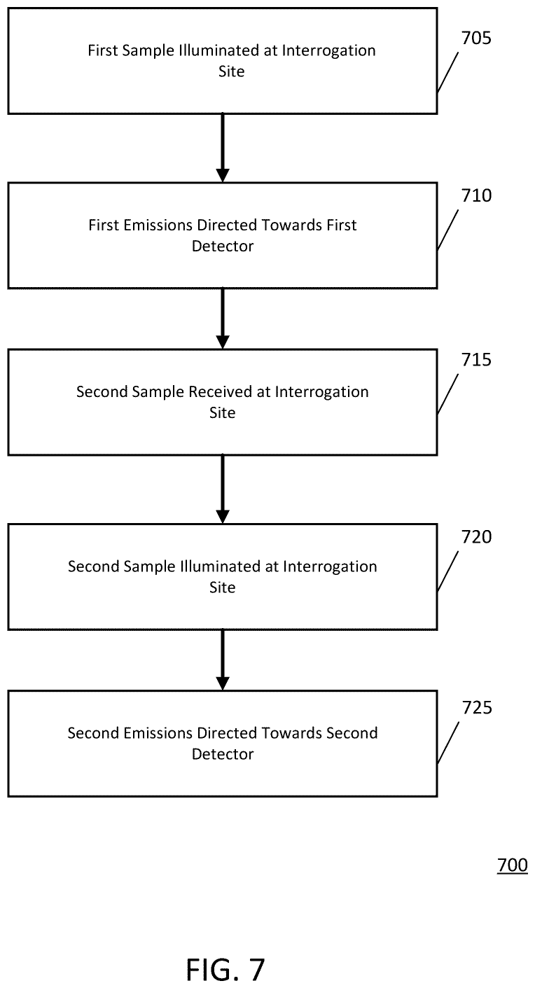

FIG. 7 depicts a process 700 for sample interrogation according to the present disclosure. The process 700 can be implemented by, for example, any of the systems 100-600 as described with reference to FIGS. 1-6.

At Step 705, a first sample can be illuminated at an interrogation site so as to give rise to first emissions. In some cases, the sample can be a cell. In some cases, the first sample can be illuminated with a laser pulse.

At Step 710, the first emissions can be directed via a first optical path towards a first detector. The first optical path can include a variety of optical components. For example, the first optical path can include a slit(s), a lens(es), a grating(s), a switching element, or a combination thereof. In some cases, the first detector can include a SPAD detector. In some cases, the first detector can be a part of a detector array.

At Step 715, a second sample can be received at the interrogation site after the first sample. In some cases, the second sample can be a cell. In some cases, the second sample can be an immediately preceding sample from the first sample.

At Step 720, the second sample can be illuminated so as to give rise to second emissions. In some cases, the second sample can be illuminated with a laser pulse (e.g., another laser pulse than the pulse used for illuminating the first sample).

At Step 725, the second emissions can be directed via a second optical path towards a second detector. In some cases, the second optical path can include a variety of optical components, including a lens(es), a grating(s), and the like. In some cases, at least a portion of a common optical pathway is convertible between a first state that includes the first optical path, and a second state that includes the second optical path. In some cases, a switching element can convert the common optical pathway between the first optical path and the second optical path. In some cases, the switching element can include a mirror, a Pockels cell, a passive element, and the like. In some cases, the second detector can include a SPAD detector. In some cases, the second detector can be a part of a detector array.

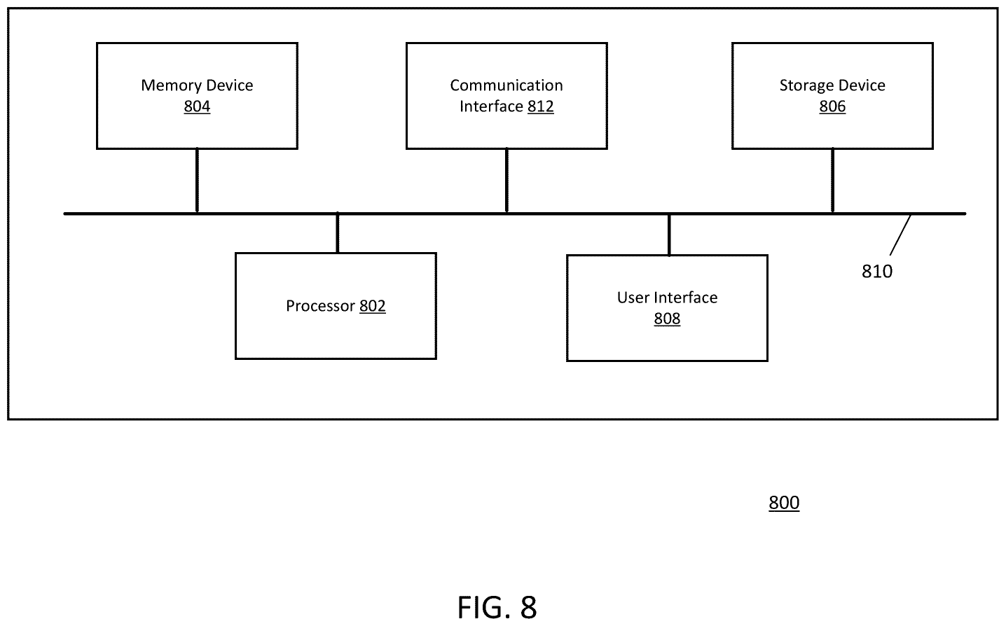

FIG. 8 depicts a controller 800 according to the present disclosure. The controller 800 can be an example of controller 145 discussed with reference to FIG. 1, or the controller 250 discussed with reference to FIG. 2.

The controller 800 can be a computing device such as a microcontroller, general purpose computer (e.g., a personal computer or PC), workstation, mainframe computer system, and so forth. The controller 800 can include a processor device (e.g., a central processing unit or “CPU”) 802, a memory device 804, a storage device 806, a user interface 808, a system bus 810, and a communication interface 812.

The processor 802 can be any type of processing device for carrying out instructions, processing data, and so forth.

The memory device 804 can be any type of memory device including any one or more of random access memory (“RAM”), read-only memory (“ROM”), Flash memory, Electrically Erasable Programmable Read Only Memory (“EEPROM”), and so forth.

The storage device 806 can be any data storage device for reading/writing from/to any removable and/or integrated optical, magnetic, and/or optical-magneto storage medium, and the like, such as a hard disk, a compact disc-read-only memory “CD-ROM”, CD-ReWritable CDRW,” Digital Versatile Disc-ROM “DVD-ROM”, DVD-RW, and so forth. The storage device 806 can also include a controller/interface for connecting to the system bus 810. Thus, the memory device 804 and the storage device 806 are suitable for storing data as well as instructions for programmed processes for execution on the processor 802.

The user interface 808 can include a touch screen, control panel, keyboard, keypad, display or any other type of interface, which can be connected to the system bus 810 through a corresponding input/output device interface/adapter.

The communication interface 812 can be adapted and configured to communicate with any type of external device, or with other components sampler interrogation system. For example, arrowed lines, such as those illustrated in FIGS. 1 and 2, can illustrate electronic communication between the controller—for example, controller 145 of FIG. 1—and another component of the sample interrogation system, for example detector 140. The communication interface 812 can further be adapted and configured to communicate with any system or network, such as one or more computing devices on a local area network (“LAN”), wide area network (“WAN”), the Internet, and so forth. The communication interface 812 can be connected directly to the system bus 810 or can be connected through a suitable interface.

The controller 800 can, thus, provide for executing processes, by itself and/or in cooperation with one or more additional devices, that can include algorithms for controlling components of the sample interrogation system in accordance with the present disclosure. The controller 800 can be programmed or instructed to perform these processes according to any communication protocol and/or programming language on any platform. Thus, the processes can be embodied in data as well as instructions stored in the memory device 804 and/or storage device 806, or received at the user interface 808 and/or communication interface 812 for execution on the processor 802.

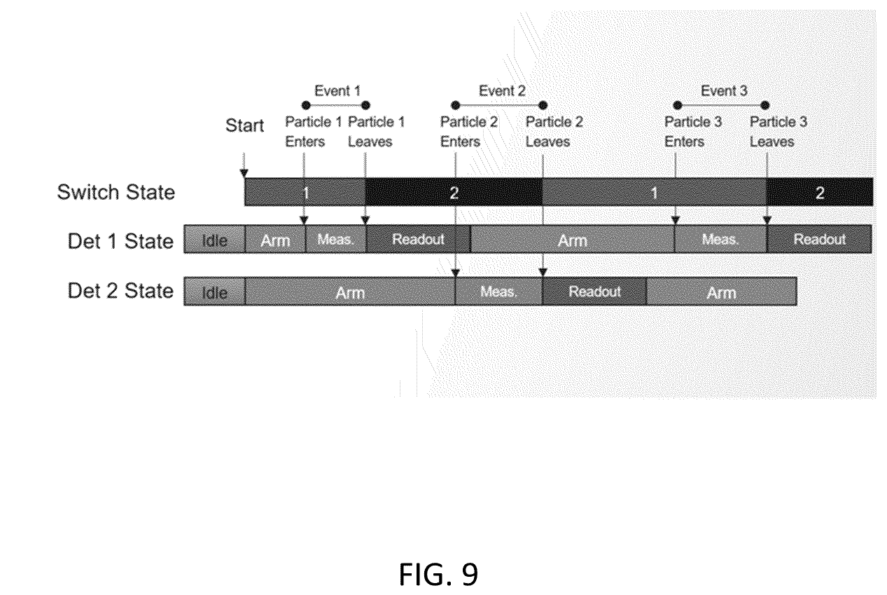

FIG. 9 depicts an example, non-limiting timeline of modes for a detector configured to be implemented according to the present disclosure. For example, the timeline depicts the states of a first detector—Det 1—and a second state—Det 2, which can be examples of detectors 245-a and 245-b, respectively, of FIGS. 2A and 2B. The modes depicted in FIG. 9 can be based on a sample entering and/or leaving an interrogation site, for example, in a position capable of generating and sending emissions to a given detector. However, in some cases, the modes can be switched based on a predefined time interval, for example, according to a time schedule; a given detector entering a readout mode; and the like.

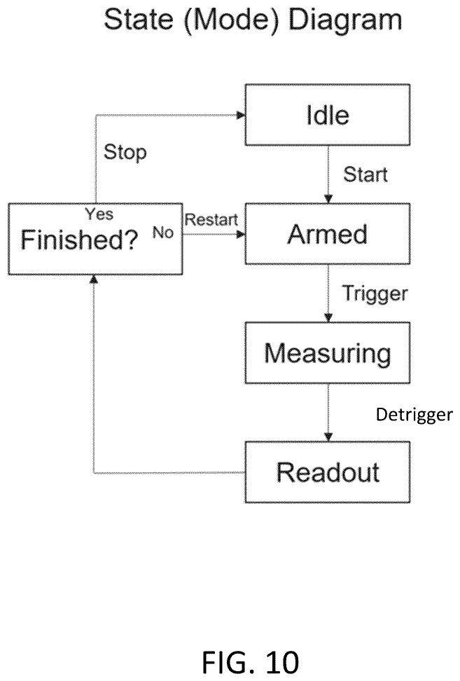

When a detector is in idle mode, the detector may be unable to collect emissions received at the detector. For example, circuitry of the detector may not be powered during idle mode. When a detector is in active mode, the detector can be capable of collecting emission. For example, the circuitry of the detector can be powered and capable of receiving emission signals from a collection layer, for example, a sensing pixel. In measuring mode, the detector can be receiving and collecting emissions. For example, collecting emissions can include storing information corresponding to the received emissions in cache memory, or other memory, of the detector. In readout mode, the detector can send information corresponding to the received emissions to another entity, such as a computing device or other “off-chip” device. FIG. 10 depicts a process for switching between these detector states. For example, triggers and de-triggers can be instructions or signals received from a controller, for example, controller 145 of FIG. 1. In some cases, the triggers can be stored “on-chip” of the detector, for example, according to a schedule or predefined time period).

### EXEMPLARY EMBODIMENTS

The following embodiments are exemplary only and do not serve to limit the scope of the present disclosure of the appended claims. It should be understood that any part of any one or more Embodiments can be combined with any part of any other one or more Embodiments.

### Embodiment 1

A light detection system, comprising: a first optical pathway configured to direct emissions from an interrogation site to a first detector; a second optical pathway configured to direct emissions from the interrogation site to a second detector; and an automated switching module configured to receive a signal that induces the automated switching module to switch between (i) a first state that directs emissions from the interrogation site to the first optical pathway or a second state that directs emissions from the interrogation site to the second optical pathway and (ii) the other of the first state and the second state.

### Embodiment 2

The light detection system of Embodiment 1, wherein the automated switching module switches between one of the first and second state and the other of the second state in response to at least one of the first and second detectors being in a readout mode.

### Embodiment 3

The light detection system of any one of Embodiments 1 through 2, wherein the automated switching module is configured to switch to the second state when the first detector is in the readout mode.

### Embodiment 4

The light detection system of any one of Embodiments 1 through 3, wherein the automated switching module is configured to switch to the first state when the second detector is in the readout mode.

### Embodiment 5

The light detection system of any one of Embodiments 1 through 4, wherein the automated switching module switches between one of the first and second state and the other of the first state and the second state in accordance with a schedule.

### Embodiment 6

The light detection system of any one of Embodiments 1 through 5, wherein the schedule comprises a predefined time interval.

### Embodiment 7

The light detection system of any one of Embodiments 1 through 6, wherein the automated switching module is configured to switch between one of the first and second state and the other of the first state and the second state upon expiration of the predefined time interval.

### Embodiment 8

The light detection system of any one of Embodiments 1 through 7, further comprising a scatter detector configured to detect scattered light from the interrogation site, and wherein the automated switching module switches between one of the first and second state and the other of the first state and the second state in response to a level of scattered light detected by the scatter detector.

### Embodiment 9

The light detection system of any of Embodiments 1 through 8, wherein the automated switching module further comprises a switching mechanism, and wherein the switching mechanism is configured to: direct emissions to the second detector via the second optical pathway and away from the first detector when the switching module is in the second state; and to direct emissions to the first detector via the first optical pathway and away from the second detector when the switching module is in the first state.

### Embodiment 10

The light detection system of any one of Embodiments 1 through 9, wherein the switching mechanism further comprises a mirror, a Pockels cell, a beam splitter, or a dual focus diffractive optical element.

### Embodiment 11

The light detection system of any one of Embodiments 1 through 10, wherein the automated switching module is further configured to cause the first detector to collect emissions during the first state, and to cause the second detector to collect emissions during the second state.

### Embodiment 12

A light detection system, comprising: a first optical pathway configured to direct emissions from an interrogation site to a first detector; a second optical pathway configured to direct emissions from the interrogation site to a second detector; and an automated switching module configured to receive a signal that induces the switching module to switch between (i) a first state in which the first detector collects emissions and the second detector does not collect emissions or a second state in the second detector collects emissions and the first detector does not collect emissions and (ii) the other of the first state and the second state.

### Embodiment 13

The light detection system of Embodiment 12, wherein the automated switching module switches between one of the first and second state and the other of the second state in response to at least one of the first and second detectors being in a readout mode.

### Embodiment 14

The light detection system of any one of Embodiments 12 and 13, wherein the automated switching module is configured to convert to the second state when the first detector is in the readout mode.

### Embodiment 15

The light detection system of any one of Embodiments 12 through 14, wherein the automated switching module is configured to convert to the first state when the second detector is in the readout mode.

### Embodiment 16

The light detection system of any one of Embodiments 12 through 15, wherein the automated switching module switches between one of the first and second state and the other of the first state and the second state in accordance with a schedule.

### Embodiment 17

The light detection system of any one of Embodiments 12 through 16, wherein the schedule comprises a predefined time interval.

### Embodiment 18

The light detection system of any one of Embodiments 12 through 17, wherein the automated switching module is configured to switch between one of the first and second state and the other of the first state and the second state upon expiration of the predefined time interval.

### Embodiment 19

The light detection system of any one of Embodiments 12 through 18, further comprising a scatter detector configured to detect scattered light from the interrogation site, and wherein the switching module switches between one of the first and second state and the other of the first state and the second state in response to a level of scattered light detected by the scatter detector.

### Embodiment 20

A system, comprising: a flow cell; an excitation source configured to illuminate a sample in the flow cell; and a light detection system according to any of Embodiments 1 through 19.

### Embodiment 21

The system of Embodiment 20, wherein the system is characterized as a flow cytometer.

### Embodiment 22

A method, comprising: causing an automated switching module to switch between (i) a first state that directs emissions from an interrogation site along a first optical pathway to first detector or a second state that directs emissions from the interrogation site along a second optical pathway to a second detector and (ii) the other of the first state and the second state; and collecting the emissions.

### Embodiment 23

The method of Embodiment 22, wherein the interrogation site is within a flow cell.

### Embodiment 24

The method of any one of Embodiments 22 and 23, wherein the emissions are related to a sample illuminated at the interrogation site.

### Embodiment 25

The method of any one of Embodiments 22 through 24, wherein the causing is in response to at least one of the first and second detectors being in a readout mode.

### Embodiment 26

The method of any one of Embodiments 22 through 25, wherein the causing is in accordance with a schedule.

### Embodiment 27

The method of any one of Embodiments 22 through 26, wherein the causing is in response to detection of a level of scattered light from the interrogation site.

### Embodiment 28

A method, comprising: causing an automated switching module to switch between (i) a first state in which the first detector collects emissions and the second detector does not collect emissions or a second state in the second detector collects emissions and the first detector does not collect emissions and (ii) the other of the first state and the second state; and collecting the emissions.

### Embodiment 29

The method of Embodiment 28, wherein the interrogation site is within a flow cell.

### Embodiment 30

The method of any one of Embodiments 28 and 29, wherein the emissions are related to a sample illuminated at an interrogation site.

### Embodiment 31

The method of any of Embodiments 28 through 30, wherein the causing is in response to at least one of the first and second detectors being in a readout mode.

### Embodiment 32

The method of any one of Embodiments 28 through 31, wherein the causing is in accordance with a schedule.

### Embodiment 33

The method of any one of Embodiments 28 through 31, wherein the causing is in response to detection of a level of scattered light from the interrogation site.

What is claimed:

1. A light detection system, comprising:
a first optical pathway configured to direct emissions from an interrogation site to a first detector;
a second optical pathway configured to direct emissions from the interrogation site to a second detector; and
an automated switching module configured to receive a signal that induces the automated switching module to switch between (i) a first state that directs emissions from the interrogation site to the first optical pathway or a second state that directs emissions from the interrogation site to the second optical pathway and (ii) the other of the first state and the second state.

2. The light detection system of claim 1, wherein the automated switching module switches between one of the first and second state and the other of the second state in response to at least one of the first and second detectors being in a readout mode.

3. The light detection system of claim 2, wherein the automated switching module is configured to switch to the second state when the first detector is in the readout mode or switch to the first state when the second detector is in the readout mode.

4. The light detection system of claim 1, wherein the automated switching module switches between one of the first and second state and the other of the first state and the second state in accordance with a schedule.

5. The light detection system of claim 4, wherein the schedule comprises a predefined time interval, and the automated switching module is configured to switch between one of the first and second state and the other of the first state and the second state upon expiration of the predefined time interval.

6. The light detection system of claim 1, further comprising a scatter detector configured to detect scattered light from the interrogation site, and wherein the automated switching module switches between one of the first and second state and the other of the first state and the second state in response to a level of scattered light detected by the scatter detector.

7. The light detection system of claim 1, wherein the automated switching module further comprises a switching mechanism, and wherein the switching mechanism is configured to: direct emissions to the second detector via the second optical pathway and away from the first detector when the automated switching module is in the second state; and to direct emissions to the first detector via the first optical pathway and away from the second detector when the automated switching module is in the first state.

8. The light detection system of claim 7, wherein the switching mechanism further comprises a mirror, a Pockels cell, a beam splitter, or a dual focus diffractive optical element.

9. The light detection system of claim 1, wherein the automated switching module is further configured to cause the first detector to collect emissions during the first state, and to cause the second detector to collect emissions during the second state.

10. A light detection system, comprising:
a first optical pathway configured to direct emissions from an interrogation site to a first detector;
a second optical pathway configured to direct emissions from the interrogation site to a second detector; and
an automated switching module configured to receive a signal that induces the automated switching module to switch between (i) a first state in which the first detector collects emissions and the second detector does not collect emissions or a second state in the second detector collects emissions and the first detector does not collect emissions and (ii) the other of the first state and the second state.

11. The light detection system of claim 10, wherein the automated switching module switches between one of the first and second state and the other of the second state in response to at least one of the first and second detectors being in a readout mode.

12. The light detection system of claim 11, wherein the automated switching module is configured to convert to the second state when the first detector is in the readout mode or convert to the first state when the second detector is in the readout mode.

13. The light detection system of claim 10, wherein the automated switching module switches between one of the first and second state and the other of the first state and the second state in accordance with a schedule.

14. The light detection system of claim 13, wherein the schedule comprises a predefined time interval.

15. The light detection system of claim 14, wherein the automated switching module is configured to switch between one of the first and second state and the other of the first state and the second state upon expiration of the predefined time interval.

16. The light detection system of claim 10, further comprising a scatter detector configured to detect scattered light from the interrogation site, and wherein the automated switching module switches between one of the first and second state and the other of the first state and the second state in response to a level of scattered light detected by the scatter detector.

17. A method, comprising:
causing an automated switching module to switch between (i) a first state that directs emissions from an interrogation site along a first optical pathway to first detector or a second state that directs emissions from the interrogation site along a second optical pathway to a second detector and (ii) the other of the first state and the second state; and
collecting the emissions.

18. The method of claim 17, wherein the causing is in response to at least one of the first and second detectors being in a readout mode.

19. The method of claim 17, wherein the causing is in response to detection of a level of scattered light from the interrogation site.
